(19) United States
(12) Patent Application Publication
(10) Pub. No.: US 2004/0205562 A1
(43) Pub. Date: Oct. 14, 2004

(54) System and method for transforming documents to and from an XML format

(75) Inventors: Matthew Rozek, Novi, MI (US); Jamin Williams, Novi, MI (US); James Jeanette, White Lake, MI (US)

Correspondence Address: FOLEY AND LARDNER, SUITE 500, 3000 K STREET NW, WASHINGTON, DC, 20007, US

(73) Assignee: G.E. INFORMATION SERVICES, INC.

(21) Appl. No.: 10/026,773

(22) Filed: Dec. 27, 2001

(51) Int. Cl. G06F 17/24

(52) U.S. Cl. 715/513; 715/523

(57) ABSTRACT

In a system method for translating between an XML-type document and a first type of document, a data model for the XML-type document is generated based on an XML data source, and a data model for the first type of document is generated based on the XML data source. Mapping rules are created between the data model for the XML-type document and the data model for the first type of document. An executable file may also be created to effect the translation between the XML-type document and the first type of document based on the data model for the XML-type document, the data model for the first type of document and the mapping rules. The executable file is run to translate between the XML-type document and the first type of document.

### FIELD OF THE INVENTION

The present invention relates generally to document management, and more particularly to a system and method for transforming documents between different formats.

### BACKGROUND OF THE INVENTION

When companies exchange documents electronically, documents are formatted in a variety of different formats. Typically, the documents are not in a format ready to be input into the intended destination application. To put these documents into the required application format, a translation process is utilized. To perform the translation, the process uses definitions of the source and target files called data models. These models define both the structures of the input and output, and the rules for moving and/or manipulating the input data to the output.

Data models representing XML syntax are considerably more complex than data models representing most other public standards. This complexity comes from using a larger number of data model items and more hierarchical levels to properly represent and process the XML syntax. Working with these data model structures requires significantly more user effort to define an environment with mapping rules.

Conventional translation systems can run an XML data model generator, which creates a data model containing the structure of the XML document without any mapping rules. However, all of the other components necessary for a translation environment must be built manually. These components include building the opposite side data model (source or target), adding mapping rules to both data models to move the data, a map component file to configure the environment, a run file to invoke the translation, and an input file to test the translation. Creating these other components and adding mapping rules to the generated XML data model requires considerable user time and effort.

### SUMMARY OF THE INVENTION

Briefly, in one aspect of the invention, a method for translating between an XML-type document and a first type of document includes generating a data model for the XML-type document based on an XML data source, and generating a data model for the first type of document based on the XML data source. Mapping rules are created between the data model for the XML-type document and the data model for the first type of document.

In another aspect of the present invention, an executable file is created to effect the translation between the XML-type document and the first type of document based on the data model for the XML-type document, the data model for the first type of document and the mapping rules. The executable file is run to translate between the XML-type document and the first type of document.

In yet another aspect of the present invention, the data model for the first type of document is modified to conform to a format associated with the first type of document, and the mapping rules are modified based on the modification of the data model for the first type of document.

In a further aspect of the present invention, formatting present in the data model for the XML-type document is omitted from the data model for the first type of document.

### BRIEF DESCRIPTION OF THE DRAWINGS

FIG. 1 is a block diagram of an embodiment of a computer network consistent with the present invention.

FIG. 2 is a block diagram of an embodiment of a translation processing system consistent with the present invention.

FIG. 3 is a flow diagram of an embodiment for creating a translation environment and performing a translation consistent with the present invention.

FIG. 4 is a flow diagram of an embodiment of a process for generating components in the translation processing system of FIG. 2.

FIG. 5 is a flow diagram of an embodiment of a process for modifying components in the translation processing system of FIG. 2.

FIG. 6 is a flow diagram of an embodiment for a validation process in the translation processing system of FIG. 2.

FIG. 7 is an example of an XSD schema definition.

FIG. 8 is an example of an XML data model generated from an XSD schema definition.

### DETAILED DESCRIPTION OF THE PREFERRED EMBODIMENT

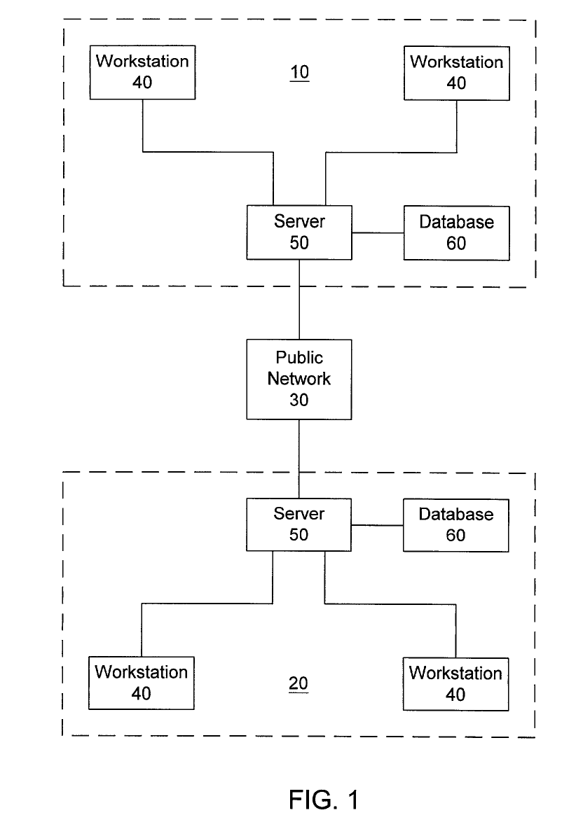

FIG. 1 is a block diagram of a computer network consistent with the present invention. As shown in FIG. 1, local networks 10 and 20 are each connected to a public network 30. Local networks 10 and 20 each include a plurality of workstations 40, a server 50, and a database 60.

Each workstation 40 may include a CPU, a main memory, a ROM, a storage device and a communication interface all coupled together via a bus. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage.

A communication interface provides a two-way data communication coupling via a network link to the networks 10 and 20 and the public network 30. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information, to and from the networks 10 and 20 and the public network 30. The networks 10 and 20 may be implemented, for example, as a LAN. The public network 30 may be implemented, for example, as the Internet.

Each server 50, like the workstations 40, may include a CPU, a main memory, a ROM, a storage device and a communication interface all coupled together via a bus. The databases 60 may be implemented as non-volatile storages that may be incorporated into the servers 50 or may be outside of the servers 50. The databases 60 may be implemented in a single storage device or in a plurality of storage devices located in a single location or distributed across multiple locations. The databases 60 store information, such as documents, and are accessible to the servers 50 and the workstations 40, in both networks 10 and 20. The information stored in the databases 60 may be stored in one or more formats, such as XML, that are applicable to one or more software applications that are used by the workstations 40 and server 50.

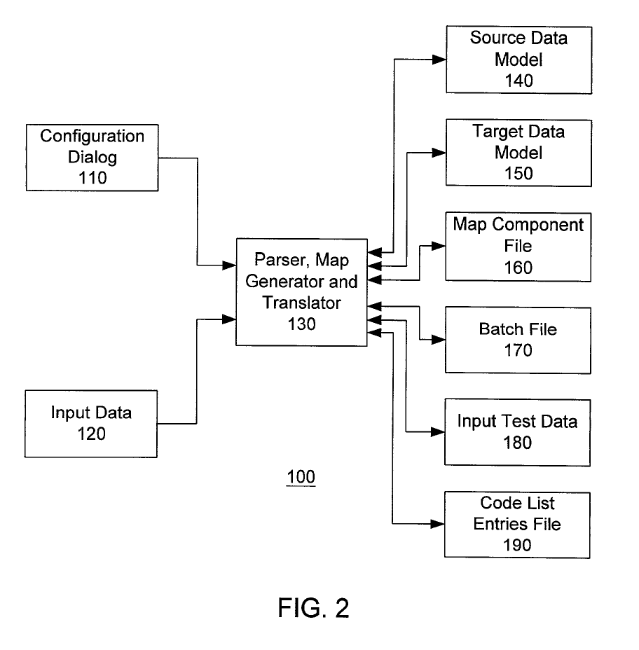

FIG. 2 is a block diagram of a translation processing system consistent with the present invention. As shown in FIG. 2, a translation processing system 100 uses a plurality of components to translate documents from one format to another. The translation processing system 100 includes a configuration dialog 110 and a parser, map generator and translator 130 (hereinafter “parser 130”). These two elements are used, along with input data 120, to create the following components: a source data model 140; a target data model 150; a map component file 160; a batch file 170; input/test data 180; and a code list entries file 190. These components are used by the parser 130 to translate the input data 120. Each of these elements will be discussed below.

The translation processing system 100 may be implemented in hardware, in software, or in some combination thereof. For example, when implemented in software, the translation processing system 100 may be stored in a storage device in the servers 50, which can be accessed and executed by any of the workstations 40 in the networks 10 or 20. Alternatively, a version of the translation processing system 100 may be stored in a storage device at each workstation 40.

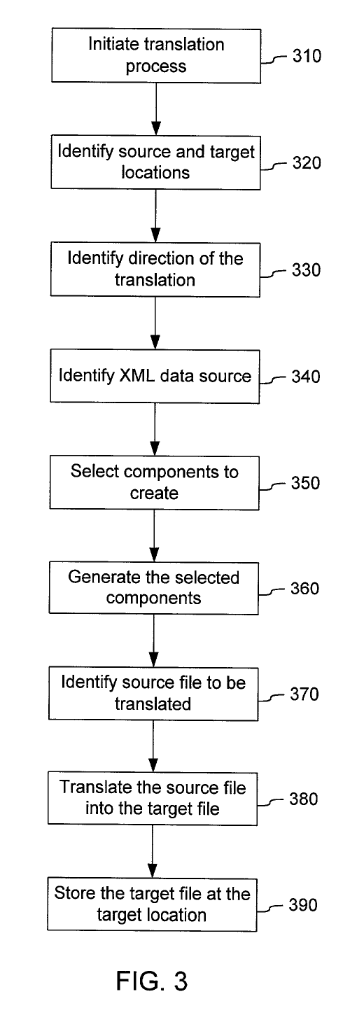

The function of the components and the operation of the translation processing system 100 will be explained in conjunction with the following description. FIG. 3 is a flow diagram of a process for creating a translation environment and performing a translation consistent with the present invention. As shown in FIG. 3, the first step is to initiate the translation process (step 310). The translation process may be initiated by a user at the workstation 40. To initiate the translation process, the user may click on an icon representing the translation processing system 100. Alternatively, the translation processing system 100 may be implemented as part of a software application, such as a document management application, that can be selected from a drop-down menu of the software application.

In response to the initiation of the translation process, the configuration dialog 110 is invoked. The configuration dialog 110 may be implemented, for example, as an automatic wizard, which prompts the user to provide the information for performing the translation process. The configuration dialog 110 first queries the user to indicate the source and target locations (step 320). The source and target locations can be located within the same or different networks 10 and 20. The specific locations can be storage devices on the workstations 40 or the servers 50 or can be the databases 60. For example, a user at a workstation 40 may identify the source location as the database 60 in the network 10 and the target location as the database 60 in the network 20.

The user then specifies the direction of the translation (step 330). The direction of translation identifies whether the document is being translated into XML or being translated from XML. It is also possible that the document is being translated between two different XML versions.

The user also identifies the XML data source (step 340). The XML data source may be a particular instance of an XML document, a data type definition (DTD) corresponding to the XML document or an XML schema definition (XSD) corresponding to the XML document. The XML document, DTD and XSD correspond to the XML format into or from which the translation is being performed. The XML data source may be located, for example, at the source or target locations, or may be located at a location independent of the source and target locations.

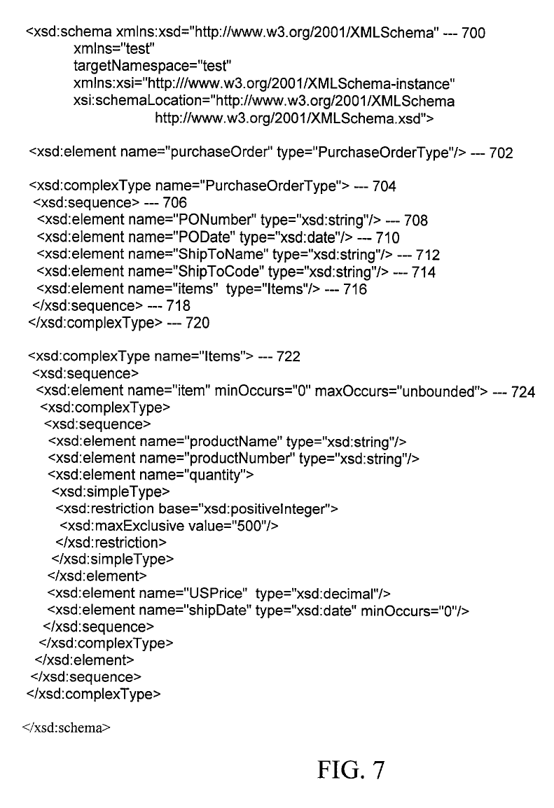

FIG. 7 is an example of an XSD schema definition. An XSD schema definition provides rules for defining what a data set should contain, and how it is organized. For example, in line 702, an XML element labeled “purchaseOrder” is defined of type “PurchaseOrderType.” A defined element in an XML document, when implemented, will have a start tag and end tag with a body. For the element purchaseOrder, the XML data would look like:

<purchaseOrder>

elements or values nested within the start and end tags

</purchaseOrder>)

In line 704, a declaration of a complexType is made with a label of “PurchaseOrderType.” This declaration consists of a sequence of other elements including: PONumber (line 708), which is a type string; PODate (line 710), which is a type date; ShipToName (line 712), which is a type string; ShipToCode (line 714), which is a type string; and items (line 716), which is a type Items. The sequence (line 706) means that the children of PurchaseOrderType must appear in this order. By default, when minOccurs and maxOccurs is not specified for elements, then they are mandatory elements and may not repeat on themselves. Lines 718 and 720 show the end tags for sequence and complexType.

As shown in FIG. 7, “string” and “date” types are defined in the namespace reference by “xsd” (xsd: is a qualifier before string & date), which is defined above on line 700 as http://www.w3.org/2001/XMLSchema. Since type “Items” is not qualified, it must be defined within this schema file, which can be found declared on line 722. For example, the minimum number of occurrences for the element ‘item’ is zero, and the maximum number of occurrences for the element ‘item’ is unbounded (line 724).

The user is further prompted by the configuration dialog 110 to select the components to create (step 350). As shown in FIG. 2, the user can create six different components, including the source data model 140, the target model 150, the map component file 160, the batch file 170, the input/test data 180, and the code list entries file 190. The source data model 140 and the target data model 150 define the structure of the data for the document being translated (source document) and for the resulting translated document (target document), respectively. Both data models preferably have a mirrored structure, although other file structures may be used. The data models also include the rules to translate the data from the source document to the target document, along with loop control logic for properly mapping repeating information.

The map component file 160 defines the components that are used for the translation. In particular, the map component file 160 identifies the names and locations of the source data model 140, the target data model 150, input/test data 180 and the code list entries file 190. The input/test data 180 is a source of data that can either be the source document that is translated into the target document or some other instance of a document that is used to test the propriety of the translation.

The batch file 170, which may also be referred to as an executable file, a run file or a shell script file, allows the user to invoke the translation for a specific implementation without the requirement of manually coding a script to execute the translation. The code list entries file 190 is a file containing lists of codes that are referenced by rules within the data models 140 and 150. The codes contained in the list define acceptable values defined by the XSD that are referenced by the data models 140 and 150.

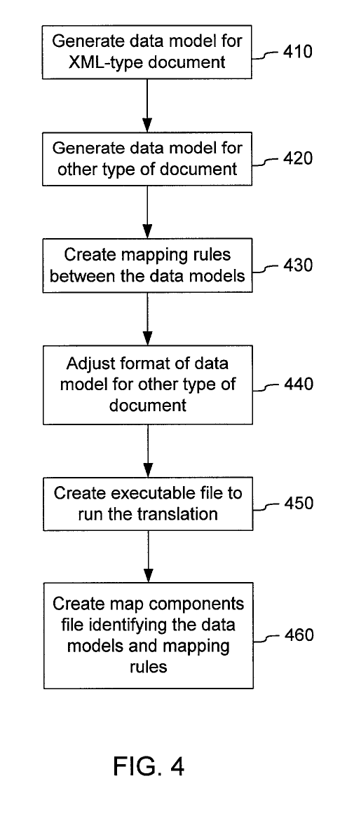

After selecting which components to create, the selected components are generated by the translation processing system 100 (step 360). With reference to the identified XML data source, the parser 130 generates the selected components. FIG. 4 is a flow diagram of a process for generating the components consistent with the present invention. As shown in FIG. 4, the parser 130 first generates the data model for the XML-type document (hereinafter “XML data model”) from the XML data source. This may be the source data model 140 or the target data model 150.

The manner in which the XML data model is generated depends on the type of XML data source. If the XML data source is a DTD, the XML data model can be generated using, for example, the DTD data model generator, a software product available from General Electric—Global Exchange Services, although other DTD-based data model generators may be used. The XML data model can also be extracted from an instance of an XML document if the XML data source is an XML document. To extract the data model, it is preferable that the applicable XML document have every field of the XML structure filled in.

If the XML data source is an XSD, a software product analogous to the DTD data model generator may be used, but modified to account for the additional data typings and constraints that are available in an XSD, but not a DTD. For example, the XSD has numeric data typings, such as integers, bytes, floating point and other numerics that limit the type of data that is proper for a particular field. The XSD can also define groupings that set forth a required order of elements or require that all elements are used. Other XSD data typings and constraints not found in DTDs include: enumerations, which define acceptable data for a field, such as the fifty states; pattern definitions, which define how data is to be represented, such as which characters are number and which ones are letters; field lengths, which define minimum, maximum or exact field lengths; and value ranges, which define minimum values, maximum values and exclusive and inclusive ranges.

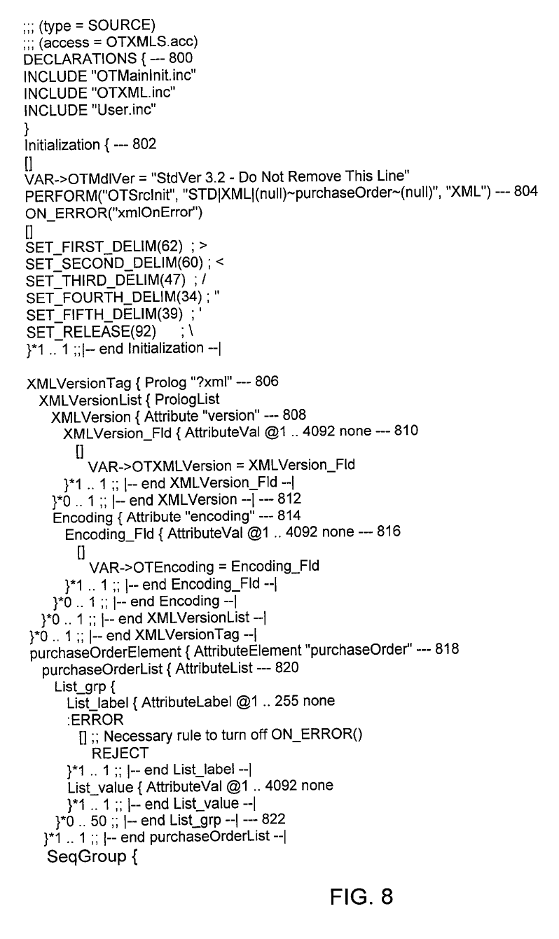

FIG. 8 is an example of an XML data model generated from an XSD schema definition. As shown in FIG. 8, the DECLARATIONS section (line 800) of the data model defines data model “include files” to be loaded that may be referenced during the execution of this data model. Using include files, common routines only need to be defined once and referenced, such as using the PERFORM( ) function, instead of fully coded in the data model every place it needs to be executed. The Initialization Group data model item (line 802), (Initialization { }*1 . . . 1), executes an include routine called “OTSrcInit” (line 804) passing in two arguments (within the double quotes), configures the error handling mode, and sets delimiters for parsing XML data.

Following Initialization is the start of the structure definition. XMLVersionTag (line 806) will parse a “Prolog” item from the input stream with a matching value of “?xml.” After parsing the string “?xml,” the attribute “version” (XMLVersion) label (line 808) and its value (XMLVersion_Fld 1 to 4092 characters) (line 810) will be parsed. Finding this is optional—the ‘0’ in “}*0 . . . 1;; |—end XMLVersion—|” (line 812) (‘;’ starts a comment on the line). Next, the “encoding” attribute label “Encoding” (line 814) and its value “Encoding_Fld” (line 816) may be parsed. The XML element labeled “purchaseOrder” (purchaseOrderElement) (line 818) will then be parsed. This element can have a plurality of attributes, up to 50—purchaseOrderList (line 820) with “}*0 . . . 50” (line 822).

After generating the XML data model, the data model for the other application (hereinafter “application data model”) is generated (step 420). The application data model is also generated based on the XML data source. As a result, the user is not required to create the application data model from scratch. The modifications or differences from the XML data model include omitting XML-type formatting or syntax to form the application data model. For example, all start and end tags of the XML data model may be omitted so that only a tag label is left with some type of delimiter to separate the tag label from the corresponding value. In addition, ID Code lookups (enumerations), which would be defined to be verified in the XML generated data model, may be omitted in the application generated data model, along with pattern and range checking. The labels for each field in the XML data model, however, are the same as the labels for each field in the application data model.

Mapping rules are then generated for the XML data model and the application data model (step 430). Since each label in the application data model is the same as the corresponding label in the XML data model, the rules for mapping between fields in each data model can be generated by matching the labels of each data model with the same names. The mapping rules are added to both the application data model and the XML data model.

The creation of the XML data model, the application data model and the mapping rules between them is performed by the parser 130 based on the XML data source. No user assistance is required to create these components other than the identification by the user of the applicable XML data source. Once these components are created, however, the user may modify each of them.

For example, the user can adjust the format of the application data model (step 440). The application data model, as described above, is generated from the XML data source, but omits some formatting and syntax that is present in the XML data model. The application associated with the application data model may have certain requirements for importing the translated document into the application. For example, the import utility of the application may require certain fields be present or require a certain format for a field. When translating the documents with the XML and application data models, the application data model can be modified so that the resulting translation conformed to the import utility requirements of the application.

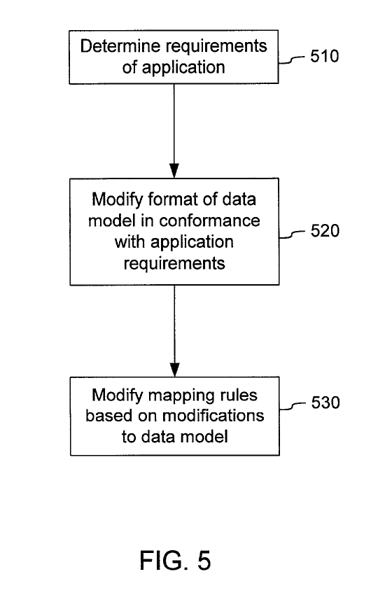

FIG. 5 is a flow diagram of a process for modifying components in the translation processing system of FIG. 2. As shown in FIG. 5, the user first determines the requirements for the application (step 510). As described above, the application may require that the translated document has certain fields, field names or field formats. The information regarding these requirements may be available from a help utility within the application or with reference to user guides provided with the application.

Based on the determined requirements for the application, the user modifies the format of the application data model (step 520). To modify the format of the application data model, the user may move any fields in the data model, delete one or more fields, change the format of the data in a field, or change any other format of the data model to enable the application data model to conform the translated document to the requirements of the import utility of the application. The translation processing system may, for example, include a graphical user interface (GUI) employing a drag and drop that assists the user in making the modifications to the application data model. Alternatively, a simple text editor may be used to modify the application data model.

In addition to modifying the application data model, the user modifies the mapping rules between the XML data model and the application data model (step 530). When the application data model is generated, the mapping rules default to matching the field labels in each data model having the same name. If the application data model is modified to conform with the import requirements of the application, then the mapping rules are typically modified to reflect the modifications made to the application data model. As with the modifications to the application data model, the translation processing system may include a GUI, a text editor or other editing application to allow the user to modify the mapping rules.

Returning to FIG. 4, with the data models and mapping rules generated and adjusted, the parser 130 creates the batch file 170 to run the translation (step 450). The batch file 170 includes executable code that references the generated data models and mapping rules to translate a document selected by the user. The executable code is created automatically by the parser 130, and does not require the user to generate the executable code from scratch. When the user runs the translation, the user invokes the created batch file 170, which executes the translation of the document selected by the user.

In addition to the batch file 170, the parser 130 creates a map component file 160 (step 460). As described above, the map component file 160 identifies the components that are used for the translation. During the execution of the batch file 170 to execute the translation, the batch file 170 references map component file 160 to determine names and locations of XML and application data models, and the mapping rules therein.

With these components created, the user can translate documents on-demand. Returning to FIG. 3, after generating the selected components, the user runs the batch file 170 to initiate the translation of a document or file. The batch file 170 may be run by issuing a run command from a command line in the translation processing system 100. The execution of the batch file 170 prompts the user to identify the source file to be translated (step 370). To identify the source file, the user may enter an address and name of the file. Alternatively, the user may use a hierarchical document organization window, such as Explorer, a product of Microsoft, and select the source file with a mouse click or keyboard entry. Instead of being prompted to identify the source file, the identity of the source file can be part of the argument invoking the batch file 170.

With the source file identified, the source file is translated into the target file (step 380). To perform the translation, the batch file 170 references the map component file 160 to identify the names and locations of the source data model 140, the target data model 150 and the code list entries file 190. The source data model 140, the target data model 150 and the mapping rules in each data model are used to transform the source file into the target file. If the source file corresponds to the XML data model, then the target file is in a format that enables the target file to be imported into the application corresponding to the application data model. Each translated field of the source file may be stored in a separate record. The conglomeration of records constitutes the target file that may be imported into the target application.

During the translation, the parser 130 may do a lookup into a table in the code list entries file 190 to make sure that the value of a field complies exists in the code list entries file 190. Within the XML data model, there may be one or more rules that indicate to the parser 130 to do the lookup into the code list entries file 190, where to perform the lookup and what item values to compare against.

The generated target file is stored at the target location (step 390). The user running the translation designated the target location prior to translating the source file into the target file. After the translation is complete, the user may also provide information for the target location regarding how to store the generated target file. This information includes, for example, a title for the document and any other relevant description information for the document. Alternatively, this information may be specified in the map component file 160.

In addition to translating documents, the translation processing system 100 includes the capability for validating the XML documents being translated. The validation process can check generally for whether the data in the document is well formed. More particularly, the validation process can check specific formatting of fields and ordering of fields to ensure that they are proper. The validation process can validate that XML data being transformed into another format is well formed. The validation process can also validate that XML data transformed from data of a different format is well formed. The validation of the XML data can be against either a DTD or an XSD schema.

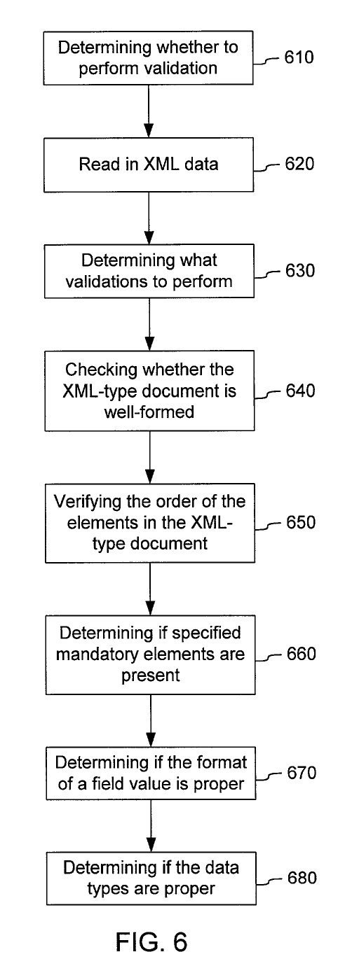

FIG. 6 is a flow diagram for a validation process in the translation processing system of FIG. 2. To determine whether or not to perform the validation, the user may be prompted before the translation begins to indicate whether or not to perform the validation (step 610). The prompt may be displayed to the user, for example, through a window. The user may indicate through the window with a click of a pointing device or a keyboard input whether or not to perform the validation. Alternatively, the validation of the XML data may be determined by a flag set in the XML data model or supplied as an argument when the translation process is invoked.

If the user elects to perform the validation, the XML data is read into the translation processing system 100 (step 620). The XML data read into the translation processing system 100 may be received by the parser 130. The XML data may be an XML document selected by the user that is being translated into another format. If the XML data is an XML document to be translated, the validation can be performed before the XML document is translated. Alternatively, the XML data may be the data resulting from the translation of a document from another format. If the XML data results from the translation from data in another format, the validation can be performed after the translation.

After reading in the XML data, the translation processing system 100 determines what validations to perform (step 630). To determine what validations to perform, the parser 130 first identifies what to use to validate the XML data. To validate the XML data, the parser 130 can use the XML data model or the DTD or XML schema used to generate the XML data model. The XML data model or the DTD or XML schema includes structures identifying particular formats or data typings for each piece of XML data and the overall structural format of the XML data, which the parser 130 identifies to determine what validations to perform. It is possible to perform more validations for more types of XML data using the XSD schema or the XML data model generated from the XSD schema as compared to the DTD or the XML data model generated from the DTD.

In addition, when generating the XML data model, from either the DTD or the XSD schema, the user can modify the XML data model to adjust the amount of validation to be performed. Modification of the data models for both structure and rules may be made using a GUI tool. Alternatively, the user can use a text editor. Modifications to the validation may be performed to reduce or open up the validation to be less restrictive. The modifications may also add more explicit restrictions, such as relationships between elements and/or attributes.

The following are examples of relationships that can be modified into the data models: ‘paired’—one present, other need to be present; ‘exclusion’—one present, other can't be present; and ‘required’—one of the items must be present. Making the validation less restrictive in the data model is not effective if validating against the DTD or XSD definition, since it continues to be the same level of validation.

Among the validations which can be performed is to check whether the XML data is well formed (step 640). In a document using XML, for example, the data is formatted with tags that indicate the start and end of different fields. The data also may have nested tags that are included in between the start and end tags of another field. To check that the XML data is well formed, the parser 130 can determine whether the start and end tags for each element or field have the same label. In addition, the parser 130 can check that all nested tags are closed in the opposite order of being opened. This validation can be performed using the DTD, the XSD schema or the XML data model.

The parser 130 can also verify the order of the elements in the XML data (step 650). The DTD, XSD schema or XML data model may specify the order in which the elements must be listed in the XML data. The parser can verify whether the order in the XML data corresponds to the order specified by the DTD, XSD schema or XML data model.

Using the DTD, XSD schema or XML data model, the parser 130 can also determine if required elements in the XML data are present (step 660). Each document having XML data may have one or more elements and/or attributes that are required to be present. The parser 130 can search the XML data, identify each element in the XML data corresponding to the one or more required elements, and determine whether all of the required elements are present.

As described above, the XSD schema allows a user to define more details about the structure and format of the XML data than the DTD. Based on these details, the parser 130 can determine if the format of a field value is proper (step 670). The XSD schema can define constraints that limit the format or value of a particular field. For example, the XSD schema can define enumerations, which define data values acceptable for a field, such as the fifty states; pattern definitions, which define how data is to be represented, such as which characters are numbers and which ones are letters; field lengths, which define minimum, maximum or exact field lengths; and value ranges, which define minimum values, maximum values and exclusive and inclusive ranges. The parser 130 can refer to these constraints and examine the XML data to determine if the value in a field satisfies any constraints associated with that field as specified by the XSD schema or the XML data model generated from the XSD schema, with reference to the code list entries file 190.

The parser 130 can also determine if the data types in the XML data are proper (step 680). As described above, the XSD schema provides for a variety of data typings including, for example, integers, bytes, floating point and other numerics that limit the type of data that is proper for a particular field. The parser 130 can refer to the data typings specified by the XSD schema or the XML data model generated from the XSD schema, with reference to the code list entries file 190, and determine if the value in a field satisfies the data type associated with that field. In addition to these constraints and data typings, the parser 130 can refer to any structural or format information in the DTD, XSD or XML data model to validate that the XML data has a proper structure and format.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for translating between an XML-type document and a first type of document, comprising:
generating a data model for the XML-type document based on an XML data source;
generating a data model for the first type of document based on the XML data source; and
creating mapping rules between the data model for the XML-type document and the data model for the first type of document.

2. A method according to claim 1, further comprising:
creating an executable file to effect the translation between the XML-type document and the first type of document based on the data model for the XML-type document, the data model for the first type of document and the mapping rules; and
running the executable file to translate between the XML-type document and the first type of document.

3. A method according to claim 1, further comprising:
translating test data based on the data model for the XML-type document, the data model for the first type of document and the mapping rules;
verifying the propriety of the data model for the XML-type document, the data model for the first type of document and the mapping rules based on the result of the translation.

4. A method according to claim 1, further comprising:
modifying the data model for the first type of document to conform to a format associated with the first type of document, and
modifying the mapping rules based on the modification of the data model for the first type of document.

5. A method according to claim 4, wherein the modifying the data model includes adjusting the data model for the first type of document to conform with an import utility of an application associated with the first type of document.

6. A method according to claim 1, wherein the generating of the data model for the first type of document includes omitting formatting that is present in the data model for the XML-type document.

7. A method according to claim 1, further comprising receiving an indication of the direction of the translation.

8. A method according to claim 1, further comprising receiving an indication of the identity of the XML data source.

9. A method according to claim 1, wherein the XML data source is an XML Schema Definition (XSD).

10. A method according to claim 9, wherein the generating of the data model for the XML-type document includes providing a model for numerics in the XSD.

11. A method according to claim 9, wherein the generating of the data model for the XML-type document includes providing a model for grouping and pattern definitions in the XSD.

12. A method according to claim 9, wherein the generating of the data model for the XML-type document includes providing a model for field lengths and value ranges.

13. A method according to claim 1, further comprising:
creating a map component file, which identifies the data model for the XML-type document, the data model for the first type of document,
wherein running the executable file includes referencing the map component file to perform the translation.

14. A method according to claim 1, further comprising receiving an indication of the identity of the XML-type document to be translated.

15. A method according to claim 1, further comprising validating that the translation between the XML-type document and the first type of document is accurate.

16. A method according to claim 15, further comprising receiving an indication of how to perform the validation.

17. A method according to claim 15, wherein the validation includes checking that the XML-type document is well-formed.

18. A method according to claim 17, wherein the checking includes determining that each element in the XML-type document has start and end tags with the same label.

19. A method according to claim 17, wherein the checking includes verifying that the XML-type document is well-formed based upon the data model for the XML-type document.

20. A method according to claim 15, wherein the validation further comprises:
determining that elements in the XML-type document are in the correct order;
determining that the XML-type document includes any specified mandatory elements;
determining if data types in the XML-type document are proper; and
determining if the format of a value in a field in the XML-type document is proper.

21. A computer readable medium on a computer system for translating between an XML-type document and a first type of document, the computer readable medium configured to:
generate a data model for the XML-type document based on an XML data source;
generate a data model for the first type of document based on the XML data source; and
create mapping rules between the data model for the XML-type document and the data model for the first type of document.

22. A computer readable medium according to claim 21, further configured to:
create an executable file to effect the translation between the XML-type document and the first type of document based on the data model for the XML-type document, the data model for the first type of document and the mapping rules; and
run the executable file to translate between the XML-type document and the first type of document.

23. A computer readable medium according to claim 21, further comprising:
translating test data based on the data model for the XML-type document, the data model for the first type of document and the mapping rules;
verifying the propriety of the data model for the XML-type document, the data model for the first type of document and the mapping rules based on the result of the translation.

24. A computer readable medium according to claim 21, further configured to:
modify the data model for the first type of document to conform to a format associated with the first type of document, and
modify the mapping rules based on the modification of the data model for the first type of document.

25. A computer readable medium according to claim 24, further configured to adjust the data model for the first type of document to conform with an import utility of an application associated with the first type of document.

26. A computer readable medium according to claim 21, further configured to omit formatting present in the data model for the XML-type document when generating the data model for the first type of document.

27. A computer readable medium according to claim 21, further configured to receive an indication of the direction of the translation.

28. A computer readable medium according to claim 21, further configured to receive an indication of the identity of the XML data source.

29. A computer readable medium according to claim 21, wherein the XML data source is an XML Schema Definition (XSD).

30. A computer readable medium according to claim 29, further configured to provide a model for numerics in the XSD.

31. A computer readable medium according to claim 29, further configured to provide a model for grouping and pattern definitions in the XSD.

32. A computer readable medium according to claim 29, further configured to provide a model for field lengths and value ranges.

33. A computer readable medium according to claim 21, further configured to:
create a map component file, which identifies the data model for the XML-type document, the data model for the first type of document; and
reference the map component file to perform the translation.

34. A computer readable medium according to claim 21, further configured to receive an indication of the identity of the XML-type document to be translated.

35. A computer readable medium according to claim 21, further configured to validate that the translation between the XML-type document and the first type of document is accurate.

36. A computer readable medium according to claim 35, further configured to receive an indication of how to perform the validation.

37. A computer readable medium according to claim 35, further configured to check that the XML-type document is well-formed.

38. A computer readable medium according to claim 37, further configured to determine that each element in the XML-type document has start and end tags with the same label.

39. A computer readable medium according to claim 37, further configured to verify that the XML-type document is well-formed based upon the data model for the XML-type document.

40. A computer readable medium according to claim 35, further configured to:
determine that elements in the XML-type document are in the correct order;
determine that the XML-type document includes any specified mandatory elements;
determine if data types in the XML-type document are proper; and
determine if the format of a value in a field in the XML-type document is proper.

41. A computer system for translating between an XML-type document and a first type of document, comprising:
a processor; and
a memory, coupled to the processor, comprising a plurality of instructions executed by the processor, the plurality of instructions configured to:
generate a data model for the XML-type document based on an XML data source;
generate a data model for the first type of document based on the XML data source; and
create mapping rules between the data model for the XML-type document and the data model for the first type of document.

42. A computer system according to claim 41, further comprising instructions configured to:
create an executable file to effect the translation between the XML-type document and the first type of document based on the data model for the XML-type document, the data model for the first type of document and the mapping rules; and
run the executable file to translate between the XML-type document and the first type of document.

43. A computer system according to claim 41, further comprising instructions configured to:
modify the data model for the first type of document to conform to a format associated with the first type of document, and
modify the mapping rules based on the modification of the data model for the first type of document.

44. A computer system according to claim 41, further comprising an instruction configured to omit formatting present in the data model for the XML-type document when generating the data model for the first type of document.

45. A computer system for translating between an XML-type document and a first type of document, comprising:
means for generating a data model for the XML-type document based on an XML data source;
means for generating a data model for the first type of document based on the XML data source; and
means for creating mapping rules between the data model for the XML-type document and the data model for the first type of document.

46. A computer system according to claim 45, further comprising:
means for creating an executable file to effect the translation between the XML-type document and the first type of document based on the data model for the XML-type document, the data model for the first type of document and the mapping rules; and
means for running the executable file to translate between the XML-type document and the first type of document.

47. A computer system according to claim 45, further comprising:
means for modifying the data model for the first type of document to conform to a format associated with the first type of document, and
means for modifying the mapping rules based on the modification of the data model for the first type of document.

48. A computer system according to claim 45, further comprising means for omitting formatting present in the data model for the XML-type document when generating the data model for the first type of document.
